(19) United States
(12) Patent Application Publication
(10) Pub. No.: US 2020/0272138 A1
(43) Pub. Date: Aug. 27, 2020

(54) SELECTION OF INDUSTRIAL SENSORS ON OBJECTS AND THEIR FEATURES

(71) Applicant: Rockwell Automation Technologies, Inc., Mayfield Heights, OH (US)

(72) Inventors: Adonis Evangelista Reyes, Billerica, MA (US); John E. Horan, Chelmsford, MA (US); Linxi Gao, Chelmsford, MA (US)

(21) Appl. No.: 16/282,730

(22) Filed: Feb. 22, 2019

(51) Int. Cl. G05B 23/02; G06F 16/9035

(52) U.S. Cl. CPC G05B 23/0216; G05B 2223/06; G06F 16/9035; G05B 23/021

(57) ABSTRACT

An industrial sensor selection system guides the process of selecting a suitable industrial sensor for use in an industrial sensing application based on information provided by the user about the application. The system can allow the user to initially specify a target product or object that is to be detected or measured by the sensing application. Based on the product selection, the sensor selection system allows the user to select from among a set of sensor use cases commonly applied to the selected product. The selection system may also prompt the user to provide additional contextual information about the selected use case. Based on the user's selection of a target product, use case, and any applicable contextual information, the sensor selection system identifies one or more suitable industrial sensors registered within a sensor profile library suitable for use within the user's sensing application.

### BACKGROUND

The subject matter disclosed herein relates generally to industrial automation systems, and, more particularly, to industrial sensor selection and specification.

### BRIEF DESCRIPTION

The following presents a simplified summary in order to provide a basic understanding of some aspects described herein. This summary is not an extensive overview nor is intended to identify key/critical elements or to delineate the scope of the various aspects described herein. Its sole purpose is to present some concepts in a simplified form as a prelude to the more detailed description that is presented later.

In one or more embodiments, an industrial sensor selection system is provided, comprising a user interface component configured to render, on a client device, interface displays that prompt for selection of a product to be detected or measured by an industrial sensing application, and in response to receiving, from the client device via interaction with the interface display, selection of the product, render sensor use cases associated with the product on the client device; and a sensor search component configured to, in response to receiving, from the client device via interaction with the interface display, selection of a sensor use case of the sensor use cases, generate search criteria data defining sensor search criteria based on the product and the sensor use case, and retrieve, from a library of sensor profiles, a subset of the sensor profiles that satisfy the sensor search criteria, wherein the user interface component is further configured to render, on the client device based on information contained in the subset of the sensor profiles, catalog information about one or more industrial sensors represented by the subset of the sensor profiles.

Also, one or more embodiments provide a method for discovering an industrial sensor suitable for an industrial sensing application, comprising receiving, from a client device by a system comprising a processor, a selection of a product to be detected or measured by an industrial sensing application; in response to receiving the selection of the product, rendering, on the client device by the system, sensor use cases associated with the product; receiving, from the client device by the system, a selection of a sensor use case of the sensor use cases; in response to receiving the selection of the sensor use case, generating, by the system, search data defining sensor search criteria based on the product and the sensor use case; retrieving, by the system from a library of sensor profiles corresponding to respective industrial sensors, a subset of the sensor profiles that satisfy the sensor search criteria; and rendering, on the client device by the system, catalog information about a subset of the industrial sensors represented by the subset of the sensor profiles based on information contained in the sensor profiles.

Also, according to one or more embodiments, a non-transitory computer-readable medium is provided having stored thereon instructions that, in response to execution, cause a system comprising a processor to perform operations, the operations comprising receiving, from a client device, a selection of a product to be detected or measured by an industrial sensing application; in response to receiving the selection of the product, rendering, on the client device, sensor use cases associated with the product; receiving, from the client device, a selection of a sensor use case of the sensor use cases; in response to receiving the selection of the sensor use case, generating sensor search data that defines sensor search criteria based on the product and the sensor use case; retrieving, from a library of sensor profiles corresponding to respective industrial sensors, a subset of the sensor profiles that satisfy the sensor search criteria; and rendering, on the client device, catalog information about a subset of the industrial sensors represented by the subset of the sensor profiles based on information contained in the sensor profiles.

To the accomplishment of the foregoing and related ends, certain illustrative aspects are described herein in connection with the following description and the annexed drawings. These aspects are indicative of various ways which can be practiced, all of which are intended to be covered herein. Other advantages and novel features may become apparent from the following detailed description when considered in conjunction with the drawings.

### BRIEF DESCRIPTION OF THE DRAWINGS

FIG. 1 is a block diagram of an example sensor selection system.

FIG. 2 is a block diagram illustrating a generalized architecture of the sensor selection system.

FIG. 3 is a block diagram illustrating an example data flow implemented by an industrial sensor search system.

FIG. 4 is a flow diagram illustrating an example high-level selection flow implemented by an industrial sensor selection system.

FIG. 5 is an example schema illustrating a possible organizational format for a product profile.

FIG. 6 is a flow diagram illustrating an example resolution of a sensor catalog number.

FIG. 7 is a flow diagram illustrating an example search-by-product selection flow that can be implemented by an industrial sensor search system.

FIG. 8 is a flow diagram illustrating an example search-by-machine selection flow for a specific curing press scenario.

FIG. 9 is a flow diagram illustrating an example search-by-industry selection flow that can be implemented by an industrial sensor search system.

FIG. 10 is an example main interface display that can be generated by a user interface component to facilitate searching for a suitable industrial sensor by specifying a type of product or object to be detected or measure.

FIG. 11 is an example interface display that can be rendered in response to selection of a cardboard box product icon.

FIG. 12 is an example interface display that can be rendered in response to selection of a beer bottle product icon.

FIG. 13 is an example search result interface display that renders information regarding sensors suitable for a sensing application.

FIG. 14 is an example interface display that can be rendered in response to selection of a More Options button.

FIG. 15 is a block diagram illustrating a generalized architecture of an industrial sensor selection system for embodiments that support proprietary product profiles.

FIG. 16a is a flowchart of a first part of an example methodology for discovering a suitable sensor for an industrial sensing application by specifying a product to be detected or measured.

FIG. 16b is a flowchart of a second part of the example methodology for discovering a suitable sensor for an industrial sensing application by specifying a product to be detected or measured.

FIG. 16c is a flowchart of a third part of the example methodology for discovering a suitable sensor for an industrial sensing application by specifying a product to be detected or measured.

FIG. 17 is an example computing environment.

FIG. 18 is an example networking environment.

### DETAILED DESCRIPTION

The subject disclosure is now described with reference to the drawings, wherein like reference numerals are used to refer to like elements throughout. In the following description, for purposes of explanation, numerous specific details are set forth in order to provide a thorough understanding thereof. It may be evident, however, that the subject disclosure can be practiced without these specific details. In other instances, well-known structures and devices are shown in block diagram form in order to facilitate a description thereof.

As used in this application, the terms “component,” “system,” “platform,” “layer,” “controller,” “terminal,” “station,” “node,” “interface” are intended to refer to a computer-related entity or an entity related to, or that is part of, an operational apparatus with one or more specific functionalities, wherein such entities can be either hardware, a combination of hardware and software, software, or software in execution. For example, a component can be, but is not limited to being, a process running on a processor, a processor, a hard disk drive, multiple storage drives (of optical or magnetic storage medium) including affixed (e.g., screwed or bolted) or removable affixed solid-state storage drives; an object; an executable; a thread of execution; a computer-executable program, and/or a computer. By way of illustration, both an application running on a server and the server can be a component. One or more components can reside within a process and/or thread of execution, and a component can be localized on one computer and/or distributed between two or more computers. Also, components as described herein can execute from various computer readable storage media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry which is operated by a software or a firmware application executed by a processor, wherein the processor can be internal or external to the apparatus and executes at least a part of the software or firmware application. As yet another example, a component can be an apparatus that provides specific functionality through electronic components without mechanical parts, the electronic components can include a processor therein to execute software or firmware that provides at least in part the functionality of the electronic components. As further yet another example, interface(s) can include input/output (I/O) components as well as associated processor, application, or Application Programming Interface (API) components. While the foregoing examples are directed to aspects of a component, the exemplified aspects or features also apply to a system, platform, interface, layer, controller, terminal, and the like.

As used herein, the terms “to infer” and “inference” refer generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

In addition, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

Furthermore, the term “set” as employed herein excludes the empty set; e.g., the set with no elements therein. Thus, a “set” in the subject disclosure includes one or more elements or entities. As an illustration, a set of controllers includes one or more controllers; a set of data resources includes one or more data resources; etc. Likewise, the term “group” as utilized herein refers to a collection of one or more entities; e.g., a group of nodes refers to one or more nodes.

Various aspects or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches also can be used.

Industrial automation applications often rely on a large number of industrial sensors of various types for detection or recognition of products, product characteristics, people, intrusive objects, machine components, or other detectable objects. These sensors can include, for example, photoelectric sensors that use an optical beam to detect the presence of objects or people at certain locations around a controlled industrial process or machine. Various types of photoelectric sensors are available, and are typically selected based on the needs or circumstances of a given industrial sensing application. For example, through-beam sensors comprise separate emitter and receiver components and control a state of an output signal based on a determination whether an optical beam emitted by the emitter component is received at the receiver component, or alternatively if a person or object positioned between the emitter and receiver components prevents the beam from reaching the receiver. Diffuse sensors comprise a sensor and emitter that reside within the same housing, and control a state of an output signal based on a determination of whether the emitted beam is reflected back to the emitter by an intrusive object. Retro-reflective sensors that emit a polarized light beam that reflects off a reflector aligned with the sensing axis of the sensor's emitter. As long as properly polarized reflected light is detected by the sensor's receiver, the sensor assumes that no objects are positioned between the sensor and the reflector. If the receiver fails to detect the polarized light, the sensor changes the state of the output signal.

Inductive sensors generate an electromagnetic field around the sensor's sensing surface and controls the state of an output signal based on disturbances to this electromagnetic field, which indicate presence of a metal object within the proximity of the sensing surface. Capacitive sensors detect the presence, distances, or levels of objects or material based on measured capacitance changes.

More sophisticated sensors can also be used to measure more granular data for objects within an industrial environment. For example, two-dimensional (2D) imaging sensors can be used to detect and identify shape and/or surface characteristics of objects within a viewing field of the sensor. In an example application, these imaging sensors may be integrated components of industrial vision systems that apply image analysis to manufactured products to verify conformity to design specifications. Industrial safety systems may also use imaging sensors to detect and identify intrusive people, vehicles, or objects within a hazardous area being monitored by the sensors. Some types of 2D imaging sensors (e.g., imaging cameras) operate by projecting a wide light beam toward an area to be monitored and collecting the reflected light reflected from the surfaces and objects within the viewing area at a receiver. Some sensors may sweep the light beam across the viewing area in an oscillatory manner to collect line-wise image data, which is analyzed to identify object edges and surfaces, surface patterns, or other such information. Alternatively, the sensor may project a stationary, substantially planar beam of light across an area of interest and collect data on objects that pass through the beam. Some 2D imaging sensors may perform grayscale or red-green-blue (RGB) analysis on the pixel data generated based on the reflected light to yield two-dimensional image data for the viewing field, which can be analyzed to identify object edges, object surface patterns or contours, or other such information.

Three-dimensional (3D) image sensors, also known as time-of-flight (TOF) sensors, are another type of sensor designed to generate distance information as well as two-dimensional shape information for objects and surfaces within the sensor's viewing field. Some types of TOF sensors determine a distance of an object using phase shift monitoring techniques, whereby a beam of light is emitted to the viewing field, and the measured phase shift of light reflected from the object relative to the emitted light is translated to a distance value. Other types of TOF sensors that employ pulsed light illumination measure the elapsed time between emission of a light pulse to the viewing field and receipt of a reflected light pulse at the sensor's photo-receiver. Since this time-of-flight information is a function of the distance of the object or surface from the sensor, the sensor can leverage the TOF information to determine the distance of the object or surface point from the sensor. Similar to 2D imaging sensors, 3D sensors can be used in industrial safety applications to identify and locate intrusive people or objects within a monitored safety area.

Within each of the many sensor categories is a broad range of industrial sensors having diverse vendors, design specifications, operating ranges, operating and configuration features, mounting options, power supply requirements, durability ratings, safety ratings, and other such sensor characteristics. Given this broad selection of available sensors of various types and specifications, selecting an appropriate industrial sensor for a given industrial sensing application requires considerable knowledge of these sensors' design specifications, and an understanding of which sensing technologies are best suited for a given sensing application. The number of available industrial sensors can be overwhelming for both end users and sales engineers alike.

To address these and other issues, one or more embodiments described herein provide an industrial sensor selection system that quickly and easily guides a user to selection of a suitable industrial sensor based on information provided by the user about the industrial sensing application within which the sensor will be used. To facilitate an intuitive selection process, some embodiments of the sensor selection system can allow the user to initially specify a target product or object that is to be detected or measured by the sensing application for which a sensor is desired. Based on the product selection, the sensor selection system allows the user to select from among a set of sensor use cases commonly applied to the selected product. The selection system may also prompt the user to provide additional contextual information about the selected use case. Based on the user's selection of a target product and use case (and, if applicable, additional contextual information about the use case), the sensor selection system identifies one or more suitable industrial sensors registered within a sensor profile library suitable for use within the user's sensing application. If multiple registered sensors are capable of carrying out the specified sensing application, the selection system may also identify distinguishing characteristics for each candidate sensor to assist the user in selecting the most appropriate sensor. In some embodiments, the sensor selection system may also provide sensor configuration recommendations for the selected sensor based on the product, use case, and contextual information provided by the user.

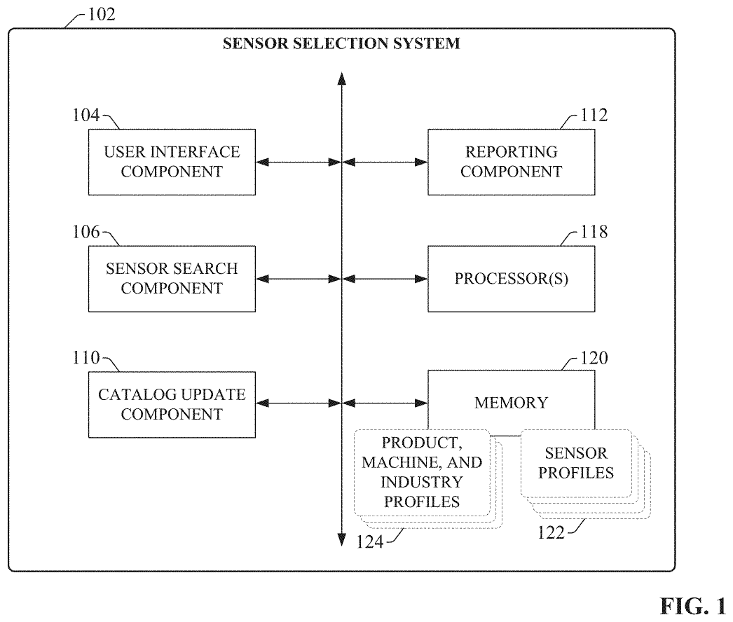

FIG. 1 is a block diagram of an example sensor selection system 102 according to one or more embodiments of this disclosure. Aspects of the systems, apparatuses, or processes explained in this disclosure can constitute machine-executable components embodied within machine(s), e.g., embodied in one or more computer-readable mediums (or media) associated with one or more machines. Such components, when executed by one or more machines, e.g., computer(s), computing device(s), automation device(s), virtual machine(s), etc., can cause the machine(s) to perform the operations described.

Sensor selection system 102 can include a user interface component 104, a sensor search component 106, a catalog update component 110, a reporting component 112, one or more processors 118, and memory 120. In various embodiments, one or more of the user interface component 104, sensor search component 106, catalog update component 110, reporting component 112, the one or more processors 118, and memory 120 can be electrically and/or communicatively coupled to one another to perform one or more of the functions of the sensor selection system 102. In some embodiments, components 104, 106, 110, and 112 can comprise software instructions stored on memory 120 and executed by processor(s) 118. Sensor selection system 102 may also interact with other hardware and/or software components not depicted in FIG. 1. For example, processor(s) 118 may interact with one or more external user interface devices, such as a keyboard, a mouse, a display monitor, a touchscreen, or other such interface devices.

User interface component 104 can be configured to exchange data with a client device, such as a desktop, laptop, or tablet computer; a mobile device such as a smart phone; or other such client device. In various embodiments, user interface component 104 can generate and deliver graphical interface displays to the client device and receive input data via a user's interaction with the interface displays. The interface displays can include prompts or selection controls that allow the user to enter information about an industrial sensing application for which an industrial sensor is to be selected, a type of product or object to be detected using the sensor, a characteristic of the product to be detected, an environment within which the sensor will operate, a type of industry within which the sensing application will operate, a type of machine on which the sensing application will be used, or other such information. The interface displays can also render information about a selected sensor, including but not limited to a catalog number identifying the sensor and specification data for the sensor.

The sensor search component 106 can be configured generate and submit search criteria to a library of digital industrial sensor profiles 122 stored on the memory 120 based on information about an industrial sensing application received via the user interface component 104, and retrieve a filtered subset of one or more industrial sensor profiles from the library that satisfy the search criteria. In some embodiments, user interface component 104 and sensor search component 106 can implement a step-wise search flow that identifies a catalog number of a suitable industrial sensor within three to five steps after an identity of a product, industry, or machine have been specified by the user. Also, in some embodiments, the search flow implemented by the sensor selection system 102 may be based in part on product, machine, or industry profiles maintained in a profile library 124 stored in memory 120. These profiles may include granular information about various types of products, machines, or industries that may be relevant to selection of a suitable sensor. The product data record in product profiles 124 may be leveraged by the search component 106 to guide the user toward an industrial sensor capable of accurately detecting or measuring a selected product or product characteristic.

Catalog update component 110 can be configured to update information in the library of sensor profiles 122 based on profile update information received from external sources (e.g., via the internet). Reporting component 112 can be configured to generate report data identifying the one or more selected industrial sensors for presentation via the user interface component 104. In some embodiments, reporting component 112 may render the one or more selected industrial sensors as a ranked list in which the sensors are ranked according to a selected criteria (e.g., suitability, cost, durability, etc.).

The one or more processors 118 can perform one or more of the functions described herein with reference to the systems and/or methods disclosed. Memory 120 can be a computer-readable storage medium storing computer-executable instructions and/or information for performing the functions described herein with reference to the systems and/or methods disclosed.

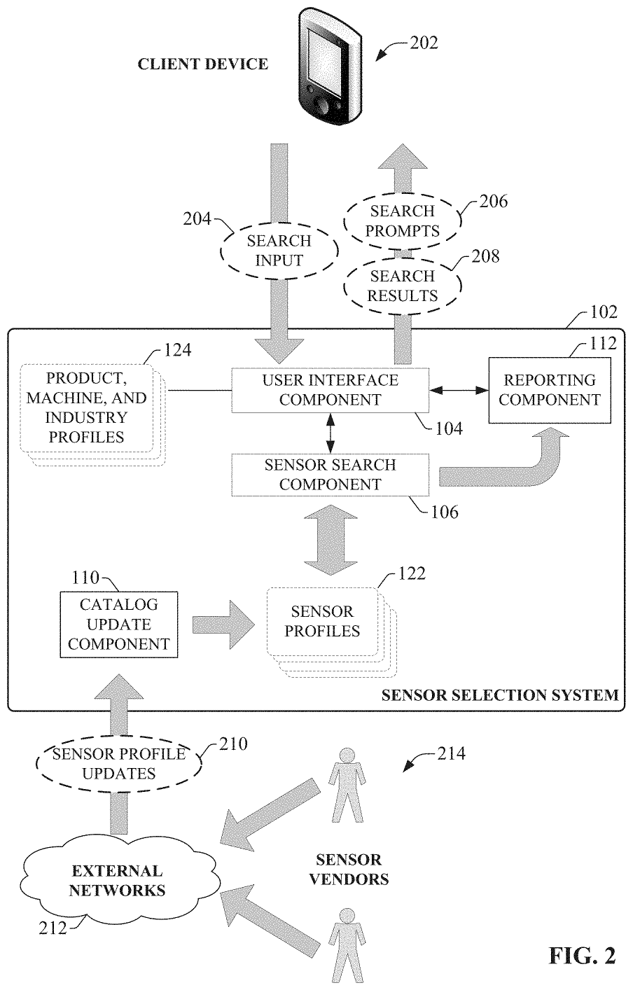

FIG. 2 is a block diagram illustrating a generalized architecture of the sensor selection system 102. In some embodiments, sensor selection system 102 may be implemented on a server or other computing device that resides on a local network with access to external networks 212 such as the Internet. In other embodiments, the sensor selection system 102 may be implemented on a web server, allowing a client devices 202 (e.g., a mobile device such as a mobile phone, a tablet computer, a laptop computer, a destktop computer, etc.) to remotely access the system 102 via a web connection. In still other embodiments, the sensor selection system 102 may be implemented as a cloud-based service that executes on a cloud platform.

As noted above, sensor selection system 102 maintains a library of sensor profiles 122, each profile 122 recording identification and specification data for a specific industrial sensor. Each sensor profile 122 can define a name and catalog number for its associated sensor, as well as design specification data for the sensor. Sensor specification data that can be defined by a sensor profile 122 can include, but is not limited to, a type of the sensor (e.g., through-beam photoelectric, diffuse photoelectric, inductive proximity sensor, imaging sensor, 3D sensor, barcode scanner, etc.), a detection range, an output signal response time, a durability rating, a safety rating (e.g., a safety integrity level, or SIL rating), an industry or type of industrial application to which the sensor is applicable, a power specification, or other such information.

In some embodiments, sensor selection system 102 can include a catalog update component 110 configured to update the library of sensor profiles 122 in accordance with sensor profile update data 210 received from external sources (e.g., via external networks 212 such as the Internet). Sensor profile update data 210 can comprise newly added sensor profiles 122 representing newly available industrial sensors, updates to previously registered sensor profiles 122 to reflect new capabilities of the corresponding sensors, instructions to delete sensor profiles 122 corresponding to discontinued industrial sensors, or other such updates. In an example scenario, sensor profile update data 210 can be submitted by sensor vendors 214 to reflect updates to their catalog of available sensors. In such cases, sensor selection system 102 may be configured to grant administrative access privileges to respective sensor vendors 214. These administrative privileges allow authorized vendor representatives to add or modify a subset of sensor profiles 122 under the purview of that vendor while preventing the representatives from accessing other sensor profiles associated with other vendors. In some embodiments, catalog update component 110 may be configured to verify credential information provided by a vendor 214 prior to allowing the vendor 214 to add or modify sensor profiles 122. Catalog update component 110 may authenticate a vendor's client device using password verification, biometric identification, cross-referencing an identifier of the vendor's client device with a set of known authorized devices, or other such verification techniques.

Sensor search component 106 is configured to search the set of sensor profiles 122 in accordance with search input 204 submitted by a client device 202 via user interface component 104. Client device 202 can exchange data with the sensor selection system 102 via a wired or wireless network interface, a near-field communication interface, or other such interface suitable for the platform on which the system 102 is implemented.

User interface component 104 is configured to serve interface displays to the client device 202 when the client device 202 requests access to the sensor selection system 102. The interface displays can include controls and prompts that guide the user through the process of entering and submitting search input 204 to the sensor selection system 102. As will be described in more detail below, the user interface component 104 renders search prompts 206 that request information about an industrial sensing application for which a sensor is required, and this information is submitted as search input 204. The search prompts 206 guide the user through a short multi-step search flow that quickly identifies one or more industrial sensors (represented by sensor profiles 122) determined to be best suited for the sensing application described by the search input. In an example search flow, the user can initiate the search by specifying a type of manufactured product or object to be detected or sensed (e.g., a bottle, a tire, a food product, etc.).

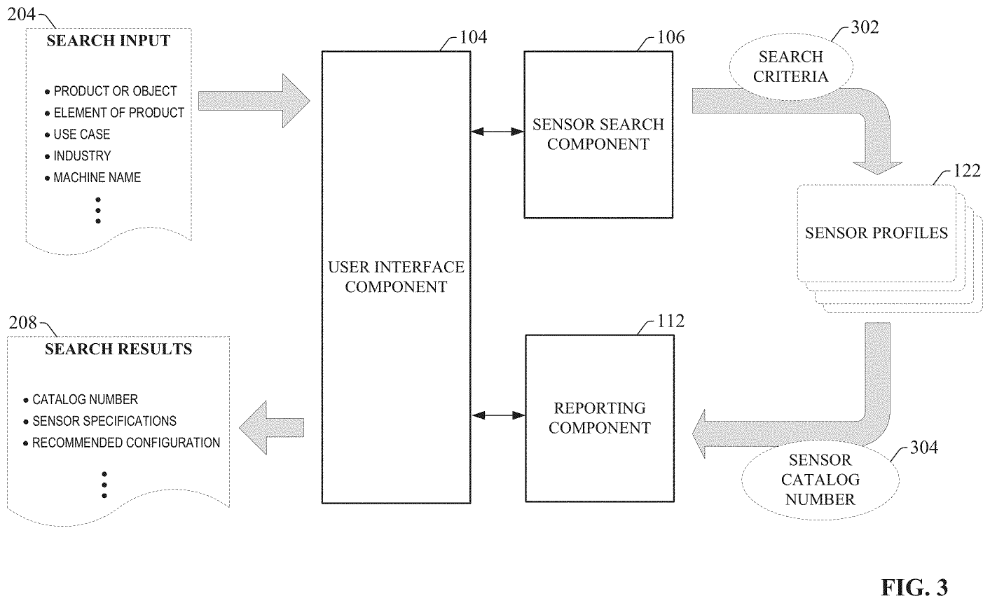

FIG. 3 is a block diagram illustrating an example data flow implemented by the sensor selection system 102. Example search criteria that can be submitted as search input 204 can include, but are not limited to, identification of a product or object to be detected or measured by the sensor (e.g., a manufactured product such as a bottle, a tire, a food product, an automotive part, etc.), a specific characteristic or element of the product to be detected or measured, a type of industrial application, a sensing use case, an industry within which the sensing application will be used (e.g., food and drug, automotive, oil and gas, textiles, etc.), a name of a machine for which the sensing application is being designed, information regarding the sensing environment within which the sensor will operate (e.g., an expected level of smoke, dust, or other pollutants in the atmosphere surrounding the sensor, an expected level of vibration that may be experienced by the sensor, a level of ambient light within the sensing environment, etc.), sensor mounting options, or other such criteria. In some embodiments, the sensor selection system 102 can allow the user to initiate the search by initially specifying either a type of product to be detected or measured, a machine to which the sensing application is to be applied, or an industry in which the sensing application will be used. User interface component 104 can then render further selection options that allow the user to provide additional use case and contextual information about the sensing application. The use case selection options presented to the user are a function of the product, machine, or industry initially identified by the user, and are defined by respective product, machine, or industry profiles stored in the profile library 124.

Once the use case information for the selected product, machine or industry has been provided, sensor search component 106 submits the user's selections as search criteria 302 to the library of sensor profiles 122 and identifies one or more sensor profiles 122 corresponding to sensors that satisfy the submitted search criteria 302. The sensor catalog number 304 and other sensor specification information is retrieved from the one or more selected sensor profiles 122 and provided to the reporting component 112, which formats the search results 208 for presentation on client device 202 by user interface component 104. In some embodiments, in addition to rendering the catalog number and sensor specification data for the selected sensor, user interface component 104 may also provide recommended configuration settings for the selected sensor based on information about the sensing application included in the search input 204.

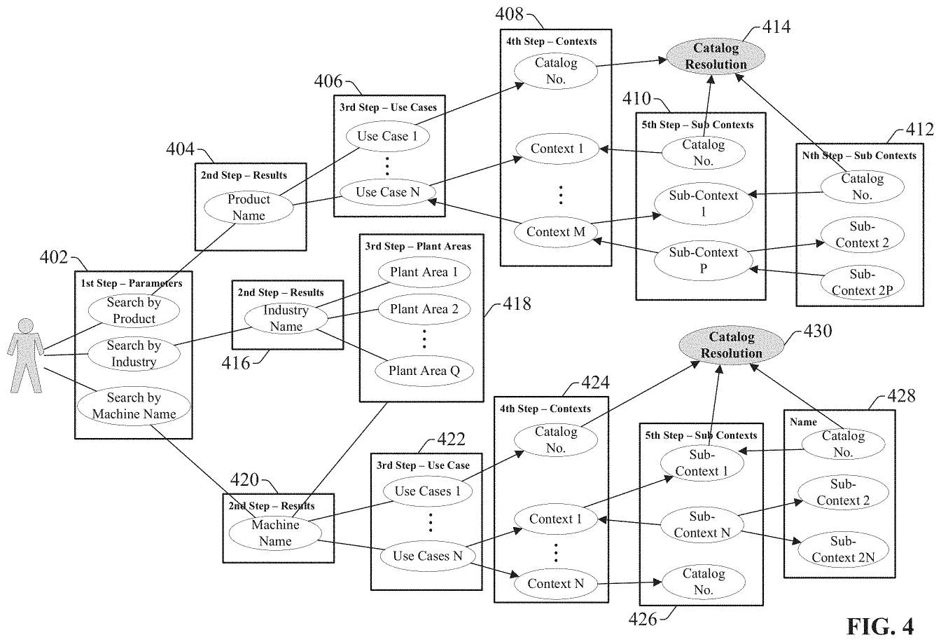

FIG. 4 is a flow diagram illustrating an example high-level selection flow implemented by the sensor selection system 102. In general, embodiments of sensor selection system 102 can implement different process flows for identifying a suitable sensor for use in an industrial sensing application, each flow depending on the user's initial choice of search parameter in the first step 402. In the example high-level flow depicted in FIG. 4, the user is offered three choices of an initial search parameter in the first step of the flow—searching for a sensor according to the product or object to be detected or measured by the sensor, searching for a sensor according to an industry within which the sensing application will be used, or searching for a sensor according to a machine for which the sensing application is being designed. Each step in the selection flow depicted in FIG. 4 (and subsequent figures depicting selection flows) can be facilitated by interface displays generated and rendered by user interface component 104, which include prompts for relevant information from the user as a function of selections made in previous steps.

In the example depicted in FIG. 4, an initial interface display corresponding to the first step 402 can prompt the user to select whether a sensor is to be selected according to a product or object to be detected, an industry, or a machine name Each of these three possible selection flows has its own selection logic, which may be driven by the sensor search component 106.

In a first example scenario, the user may choose, in the first step 402, to search for a suitable industrial sensor by initially specifying the product or object to be measured or detected by the sensor. In some embodiments, the user can enter a name of the product or object in a search field of an interface display rendered by user interface component 104. The user interface component 104 compares the text of the user's product name entry with the available product profiles registered in the profile library 124 and, in the second step 404, renders one or more product name results that either exactly or approximately match the user's product name entry. The user can then select one of the candidate product results at the second step 404 in order to proceed to the next step. As an alternative to receiving the product name as alphanumeric text entered by the user, some embodiments of user interface component 104 may render graphical icons representing different products or product types currently registered in the profile library 124, and allow the user to select a product by selecting the appropriate product icon.

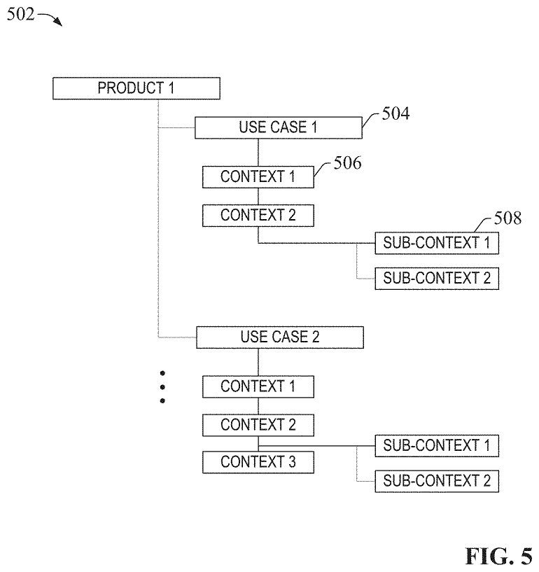

Each product profile registered in profile library 124 defines possible use cases and associated contextual options relating to its product or product type. FIG. 5 is an example schema illustrating a possible organizational format for a product profile 502 according to one or more embodiments. The product profile 502 can define, for its associated product (e.g., Product 1), sensor use cases 504 that are commonly applied to the product. When the product is selected by the user at the second step 404 of the selection flow, user interface component 104 references the selected product's profile 502 and renders the use cases defined in the profile 502 as selectable options. As will be described in more detail below, some use cases 504 may be associated with additional contextual options (represented by context nodes 506 in FIG. 5), which are rendered as further selectable options. Likewise, some contexts may have associated sub-contexts 508, which are also rendered as selectable options in association with their associated contexts 506.

With the product name resolved at the second step 404, the third step 406 allows the user to select or otherwise identify a specific use case indicating how the industrial sensor will be used with respect to the product selected at the second step 404. As noted above, the product profile for the product selected at the second step 404 can define a set of typical sensor use cases for the product. Accordingly, user interface component 104 may render these common use cases based on the use case definitions in the product profile and allow the user to select (via interaction with a graphical display) the use case that most closely matches the industrial sensing application for which the sensor is being selected. Typically, the use cases offered at the third step 406 depend on the product or product type selected at the second step 404. For example, if the selected product is a physical article of manufacture having characteristics that commonly require verification or detection during the manufacturing process, the use cases may comprise a list of these product characteristics (e.g., part alignment, label presence, cap presence, color, size, etc.). Other example use cases that may be selected by the user (depending on the type of selected product) can include, but are not limited to, product presence verification (e.g., verifying that the product is present at a particular workstation), web tension control, paper roll diameter measurement, vision, label barcode scanning, label presence verification, fill level verification or measurement, or other such use cases.

At the third step 406, depending on the use case selected at the third step 406, user interface component 104 may render one or more catalog numbers of a subset of registered industrial sensors (selected from the sensor profiles 122) capable of performing the selected use case. Alternatively, if the sensor selection can be further refined with additional contextual information about the selected use case (as defined by the product profile's hierarchical schema), user interface component 104 may render a set of contexts (e.g., Context 1 through Context M) relating to the selected use case for selection by the user. In this way, a series of hierarchical use cases, contexts, and sub-contexts can be selectively traversed by the user (e.g., at the fifth step 410 through an Nth step 412, depending on how many sub-contexts are defined for a given use case) via interaction with the interface displays rendered by user interface component 104.

As these use cases and associated contexts and sub-contexts are selected by the user, sensor search component 106 incrementally narrows the subset of eligible industrial sensors determined to be suitable for use within the selected contexts and sub-contexts until no further selectable contexts or sub-contexts are available. At the end of this selection process, one or more catalog numbers representing a subset of registered industrial sensors suitable for use in the selected use case and contexts are obtained (represented by the “Catalog No.” nodes in the 4^{th} through N^{th} steps). User interface component 104 renders this set of suitable sensor catalog numbers for selection (resolution) by the user.

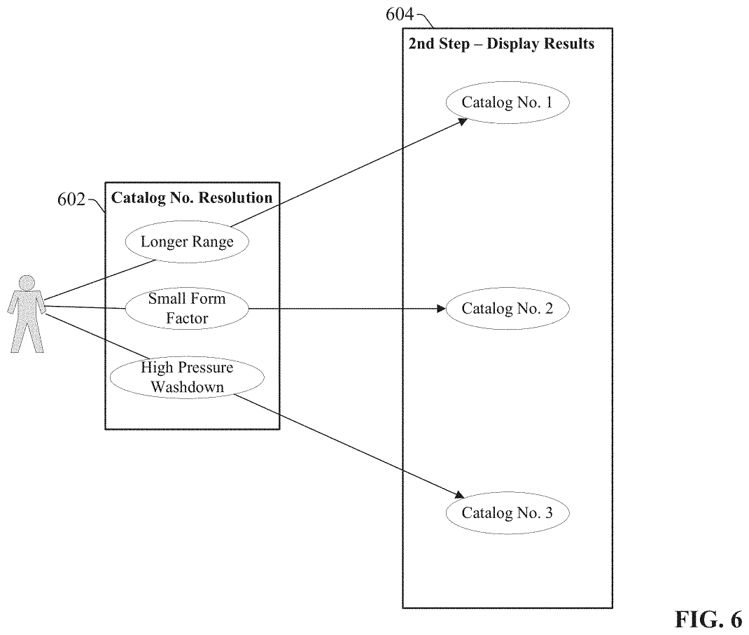

FIG. 6 is a flow diagram illustrating an example resolution of a sensor catalog number when selection system 102 determines that multiple registered sensors are suitable for the selected product sensing use case and associated contexts and sub-contexts. In some embodiments, reporting component 112 can render the set of candidate sensor catalog numbers together with indications of respective capabilities or properties that distinguish each sensor from the other candidate sensors. In the example depicted in FIG. 6, the system has identified three eligible sensors suitable for use within an industrial sensing application defined by the product, use case, context, and sub-contexts (if any) selected by the user. Based on specification data recorded in the sensor profiles corresponding to the respective eligible sensors, reporting component 112 identifies a distinguishing characteristic for each eligible sensor that may assist the user in making an informed selection from among these eligible sensors, and formats the presentation of the three eligible sensors so that the distinguishing characteristics are rendered in association with their respective sensors. In the present example, a first of the three sensors supports a longer sensing range than either of the other two eligible sensors, a second sensor has a smaller form factor than either of the two other sensors, and a third sensor has a highest durability of the eligible sensors, making that sensor suitable for high-pressure machine washdowns. Other example distinguishing sensor characteristics that can be used to uniquely characterize eligible sensors can include, but are not limited to, lowest cost, fastest output signal response time, most reliable in high-pollution environments, most energy efficient, highest safety rating, or other such characteristics.

User interface component 104 can render these eligible sensors together with their distinguishing characteristics as selectable options at the catalog number resolution step 602. The user can select one of these candidate sensors via interaction with the interface display, thereby resolving the selection process to a single sensor catalog number at the second step 604 (corresponding to node 414 in FIG. 4). Upon resolution of the candidate sensors to a single sensor, user interface component 104 can render additional functional specification data for the selected sensor. In some embodiments, the user interface component 104 can also generate and render recommended configuration settings for the selected sensor based on the product, use case, and contextual information provided by the user. These recommended configuration settings are designed to optimize performance of the selected sensor within the sensing application defined by the product, use case, and contextual data.

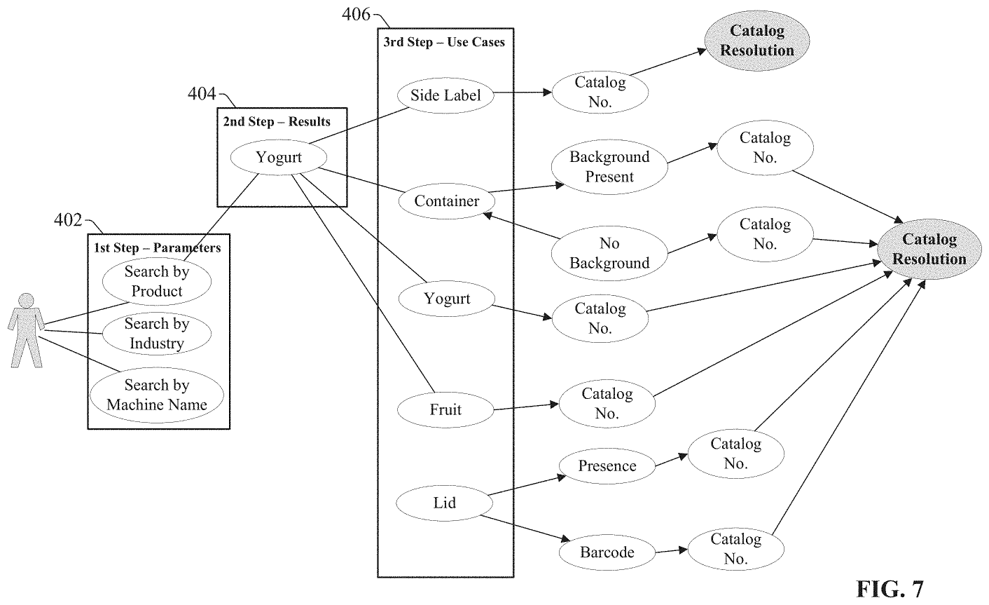

FIG. 7 is a flow diagram illustrating an example search-by-product selection flow for a specific product according to one or more embodiments. In this example, the user requires a sensor for use in connection with a yogurt packaging line. Accordingly, the user enters or selects “yogurt” as the product in the appropriate search-by-product area of the interface display at the first step 402. In some embodiments, user interface component 104 may first render available product categories that includes “Food” or “Food and Drug” as one of the categories. Selection of this category may cause user interface component 104 to render specific products under that category, including “Yogurt,” which can then be selected as the target product.

According to the product profile 124 for product “yogurt,” there are five typical sensor use cases relating to yogurt packaging and handling. These use cases are (1) detection of a side label on the yogurt container (“Side Label”), (2) confirmation that the container is present before filling with product (“Container”), (3) confirmation that yogurt is present in the container (“Yogurt”), (4) confirmation that fruit is present in the container (“Fruit”), and (5) lid detection (“Lid”). User interface component 104 renders these use cases for selection by the user in the third step 406.

Some use cases—namely, Side Label, Yogurt, and Fruit—have no associated contexts or sub-contexts, and so selection of one of these use cases causes sensor search component 106 to obtain a set of one or more sensor catalog numbers suitable for the selected use case without prompting the user for additional contextual information about the use case. Selection of either of the other use cases—Container and Lid—causes user interface component 104 to prompt the user for further contextual information about the selected use case. For the Container use case, multiple registered 2D or 3D sensors may be capable of detecting the presence of the container, some of which support background monitoring if a fixed background is present in the monitored area. Accordingly, selection of the Container use case in the third step 406 causes user interface component 104 to prompt the user to identify whether a fixed background is present in the area to be monitored. Based on the user's selection (Background Present or No Background), user interface component 104 renders a suitable set of sensor catalog numbers (obtained by sensor search component 106 based on the user's selections) for resolution by the user (e.g., using a process similar to that described above in connection with FIG. 6). Similarly, selection of the Lid use case may imply that the user requires a sensor to either detect the presence of the lid on the container (“Presence”) or read a barcode printed on the lid (“Barcode”). Accordingly, selection of the Lid use case cause the user interface component 104 to prompt the user for the desired application (Presence or Barcode), and to render an appropriate set of sensor catalog numbers based on the selected application.

The foregoing examples demonstrate selection of a suitable sensor for a given industrial sensing application by initially specifying a product to be detected or measured. As noted above, sensor search system can also support search flows in which the user initially specifies an industry in which the sensing application will be used or a machine on which the sensing application will be used as an alternative to specifying a product or object to be detected. Returning to FIG. 4, it can be seen that the selection flow for selecting a suitable sensor based on the machine on which the sensing application is to be deployed (Search by Machine Name), is similar to the product-based selection flow. In response to receipt of a machine name from the user at the first step 402, user interface component 104 renders one or more machine name search results at the second step 420 that closely match the user's specified machine name The machine name results are retrieved from machine profiles registered in the profile library 124. Alternatively, user interface component 103 may render a complete list of machines or machine types registered with the system 102 for selection by the user.

Since some types of machines comprise several sub-systems or smaller machines, some embodiments of sensor selection system 102 can allow the user to navigate a tree of hierarchical machine definitions that define high-level machine types and, for each defined machine type, the sub-systems or sub-machines associated with that machine type. Machine selection interface displays rendered by the user interface component 104 can guide the user through sequential selection of these sub-machines until making a final selection of a machine at a lowest level of the hierarchical path.

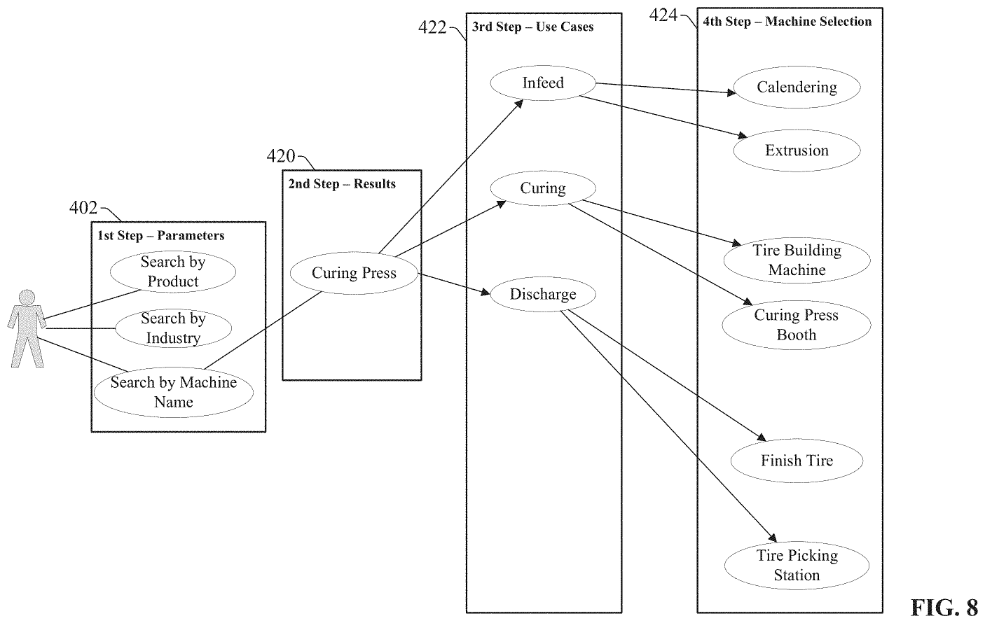

FIG. 8 is a flow diagram illustrating an example search-by-machine selection flow for a specific curing press scenario. In this example, the user has entered or selected a curing press at the machine of interest. The curing press profile stored in profile library 124 indicates that a curing press is made up of three stages—infeed, curing, and discharge. Based on information retrieved from the registered curing press profile, user interface component 104 renders these three stages for selection at the third step 422. The curing press profile further indicates that each of these three stages comprises multiple machines. The infeed stage comprises a calendaring machine and an extrusion machine, the curing stage comprises a tire building machine and a curing press booth, and the discharge stage comprises a finish tire machine and a tire picking station. Upon selection of one of the stages in the third step 422, user interface component 104 renders the set of machines associated with that stage for selection at the fourth step 424.

It is to be appreciated that the curing press stages and sub-systems depicted in FIG. 8 are only intended to be exemplary. In general, any type of machine and associated stages and subsystems can be registered in the profile library 124 and traversed by the user using a similar methodology. Also, although the example depicted in FIG. 8 requires three steps in order to select a lowest-level machine in the machine hierarchy, some initial machine selections may require more or less than three steps in order to fully resolve machine selection. For example, some initial machine selections may have no associated stages or sub-machines and therefore only require one step, while other initial machine selections of higher complexity may require more selection steps in order to fully resolve the machine selection.

Returning now to FIG. 4, once a machine has been selected in this manner, subsequent resolution of a sensor catalog number can follow a similar procedure to that described above in for the search-by-product scenario. For example, after a machine has been selected, user interface component 104 can render a set of possible industrial sensor use cases relating to the selected machine for selection by the user. Selection of a use case may also cause the system 102 to render subsequent contexts and sub-contexts relating to the selected use case. These contexts and sub-contexts can be sequentially selected by the user (e.g., at steps 424, 426, and 428 in FIG. 4) until the sensor search component 106 has sufficient information about the user's sensing application to identify a final sensor catalog number (represented by node 430) suitable for the user's application. In some cases, sensor search component 106 may determine that multiple registered sensors satisfy the requirements of the user's sensing application. In such cases, a final catalog number can be resolved using the technique described above in connection with FIG. 6.

In a similar fashion, sensor selection system 102 can allow the user to initiate the search for a suitable industrial sensor by specifying an industry of focus at the first step 402 as an alternative to specifying an initial product or machine name. The selected industry represents a type of industry in which the sensing application will be used. As shown in the general flow of FIG. 4, selection of an industry name at steps 416 (based on an initially search-by-industry input at step 402) causes user interface component 104 to render a set of plant areas typically associated with the selected industry for selection at step 418. The plant areas associated with a given industry can be defined in respective industry profiles registered in profile library 124.

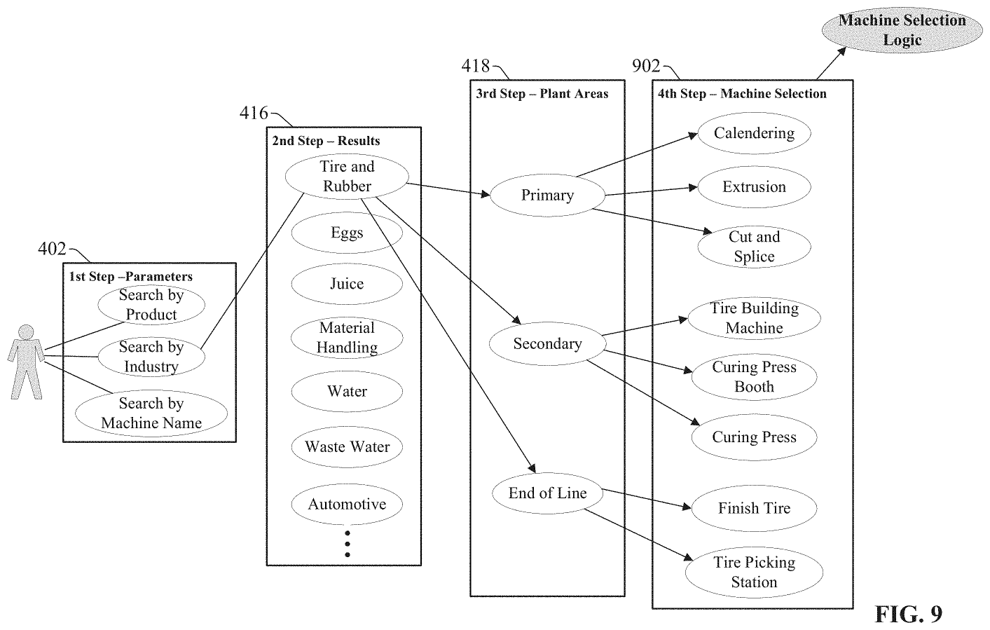

FIG. 9 is a flow diagram illustrating an example search-by-industry selection flow that can be implemented by sensor selection system 102. In this example, the user enters an industry at the first step 402 via interaction with the main interface display rendered by the user interface component 104, and a list of candidate industries matching the user's entry is rendered in the second step 416. Alternatively, user interface component can render a list of registered industries for selection by the user. In some embodiments, sensor selection system 102 can allow the user to navigate through a tree of hierarchical industry definitions that define high-level industries, with more specific industries classified under each high-level industry. For example, the industry classifications may define “Automotive” as a high-level industry having a number of sub-industries—e.g., “Tire and Rubber,” “Painting,” “Welding,” “Engine,” etc.—defined underneath this high-level classification. Other example industries or sub-industries can include, but are not limited to Oil and Gas, Food and Drug (e.g., Eggs, Juice, Liquid Medication, Tablets, etc.), Utilities (e.g., Water, Waste Water, etc.), Power and Energy, Textiles, Paper, Material Handling, Marine, etc.

Selection of an industry at the second step 416 causes the user interface component 104 to prompt the user for specifics of the plant area or production line in which the sensing application will be installed (the third step 418). The plant areas or production lines presented to the user for selection at the third step 418 are a function of the industry selected in the second step 416 and are obtained by the user interface component 104 from the relevant industry profile registered in the profile library 124. In the example illustrated in FIG. 9, the Tire and Rubber industry is associated with three possible plant areas that are specific to that industry—Primary, Secondary Processes, and End of Line. In response to selection of the Tire and Rubber industry at the second step 416, these use cases are rendered for selection at the third step 418.

Selection of one of these use cases at the third step 418 causes the user interface component 104 to prompt the user for selection of a relevant machine associated with the selected area (also obtained from the industry profile). For example, the Primary area may include a calendaring machine, an extrusion machine, and a cut-and-splice machine (as defined by the Tire and Industry profile maintained in profile library 124). The Secondary area may include operations by a tire building machine, a curing press booth, and a curing press. The End of Line area may include a finish tire machine and a tire picking station. Selection of one of the areas in the 3^{rd} step 418 causes the corresponding set of related machines to be rendered for selection at the 4^{th} step 902. Upon selection of a machine at the 4^{th} step 902, selection logic can proceed in a similar manner as that described above for the search-by-machine approach. That is, step 902 in FIG. 9 is equivalent to machine selection step 420 in FIG. 4. As such, once a machine has been selected at step 902 during a search-by-industry sequence, the system 102 can sequentially render any relevant use cases, contexts, and sub-context associated with the selected machine via steps 422, 424, 426, and/or 428 (or additional steps if needed) until a sensor catalog number is resolved (node 430).

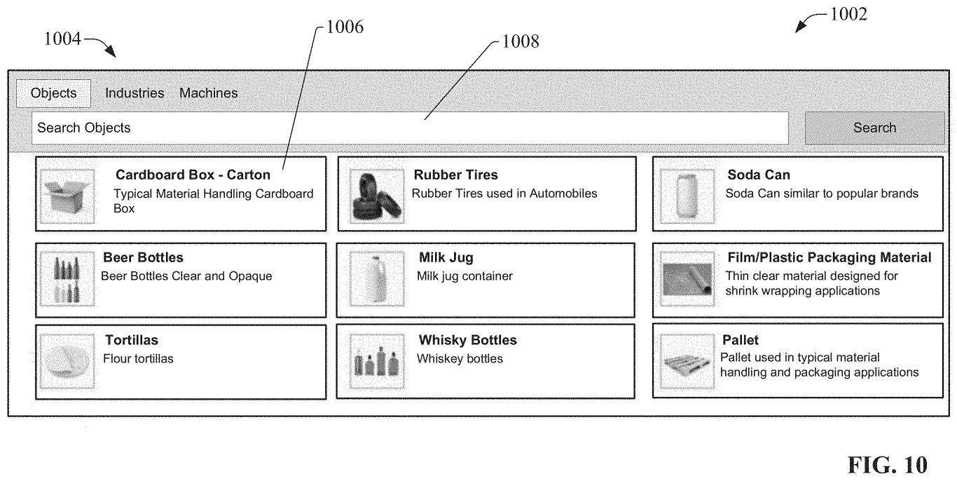

FIG. 10 is an example main interface display 1002 that can be generated by the user interface component 104 to facilitate searching for a suitable industrial sensor by specifying a type of product or object to be detected or measure (a search-by-product flow). It is to be appreciated that interface display 1002 is only intended to be exemplary, and that any suitable graphical interface capable of guiding the user through the search flows described above is within the scope of one or more embodiments of this disclosure. Interface display 1002 includes a search type selection area 1004 that allows the user to select the type of sensor search flow to be performed—search by products/objects, search by industries, or search by machines. In the present example the option to search by products/objects has been selected, causing the user interface component 104 to render a set of selectable product icons 1006 representing respective different types of products or objects. The product icons that are rendered for selection depend on the product types that are registered in the profile library 124. Example products can include, but are not limited to, cardboard boxes, rubber tires, soda cans, beer bottles, milk jugs, packaging material, tortillas (or other food items), whiskey bottles, pallets, automotive engine blocks (or other automotive components), or other such products. As an alternative to selecting one of the displayed product types, the user can enter a product search term in a search field 1008 rendered along the top of the interface display 1002.

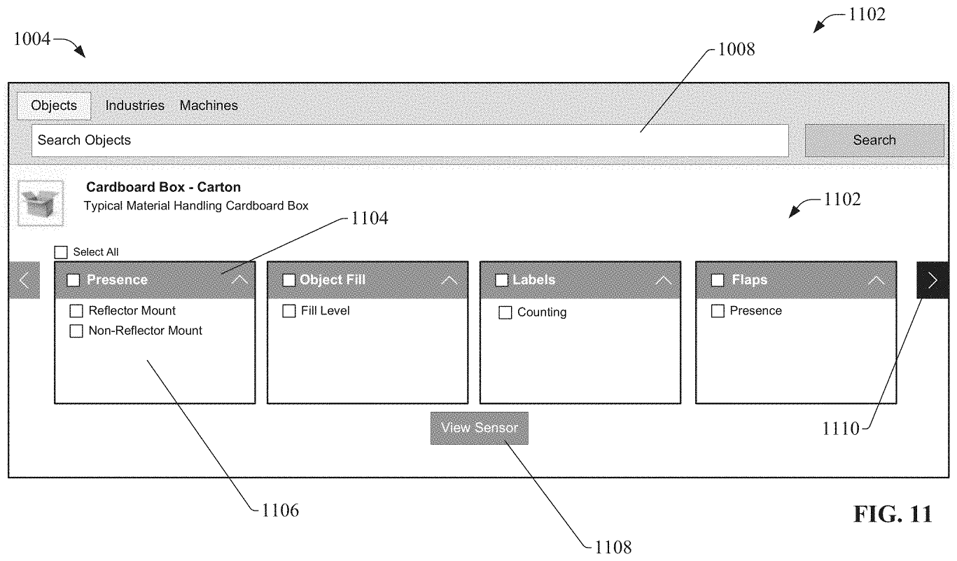

In response to selecting one of the product icons 1006, user interface component 104 renders common sensor use cases specific to the selected product. FIG. 11 is an example interface display 1102 that can be rendered in response to selection of the cardboard box product icon 1006. Based on information in the cardboard box profile registered in profile library 124, user interface component 104 renders a set of sensing use cases 1104 representing possible characteristics or behaviors of a cardboard box to which a sensing application may be directed. Example cardboard box sensing use cases can include, for example, confirming presence of the box at a given work station (Presence), confirming that an object or material has been placed in the box (Object Fill), confirming that a label has been properly affixed to the box (Labels), confirming a presence or position of the box's flaps (Flaps), detecting the proper application of glue on the cardboard box, or other such use cases).

Below each use case 1104 is a context area 1106 listing any contextual options that may be associated with the use case. Options listed in the context area 1106 represent the contexts and sub-contexts discussed above. Selection of a context and sub-context (reflecting the nature of the sensing application for which a sensor is required) can refine the sensor search criteria applied by the sensor search component 106 to identify an appropriate sensor. In the example illustrated in FIG. 11, the Presence use case allows the user to specify, in its associated context area 1106, whether the sensor mounting area permits installation of a reflector (thereby including reflector-type sensors in the search results). The Object Fill use case allows the user to specify whether a fill level of a product inside the box is to be measured. The Labels use case allows the user to specify whether labels are to be counted. The Flaps use case allows the user to specify whether the presence of the flaps is to be determined by the sensor. Scroll buttons 1110 can be used to scroll through the list of use cases if necessary.

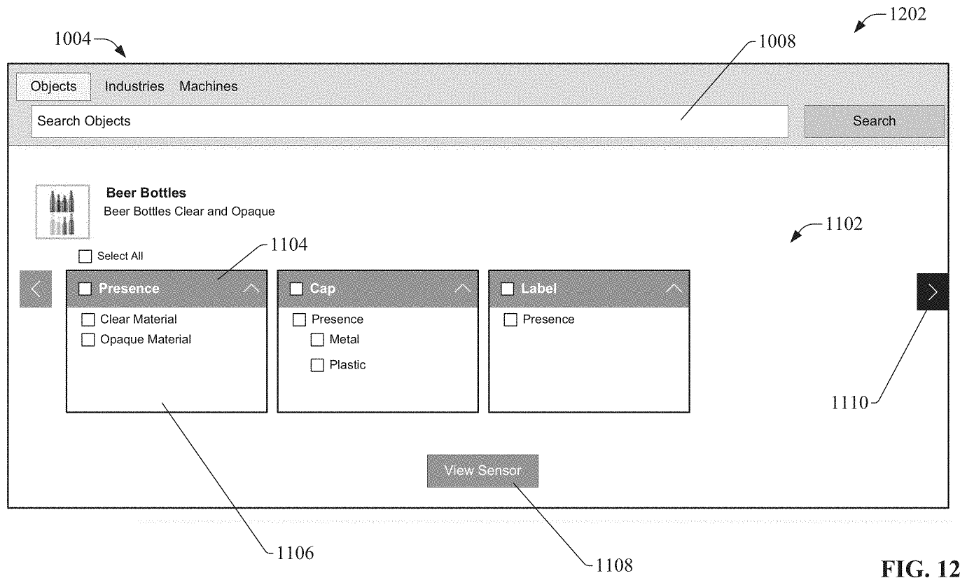

FIG. 12 is another example interface display 1202 that can be rendered in response to selection of the beer bottle product icon 1006 on interface display 1002, illustrating example use cases and contexts that can be associated with that product. In this example, sensor use cases and associated contexts that can be selected for the Beer Bottle product include bottle presence (including selectable contexts that allow the user to specify whether the bottle is made of a clear material or an opaque material), cap presence (including a sub-context allowing the user to specify whether the cap is metal or plastic, which may dictate the type of sensor sued to detect the cap), and label presence.

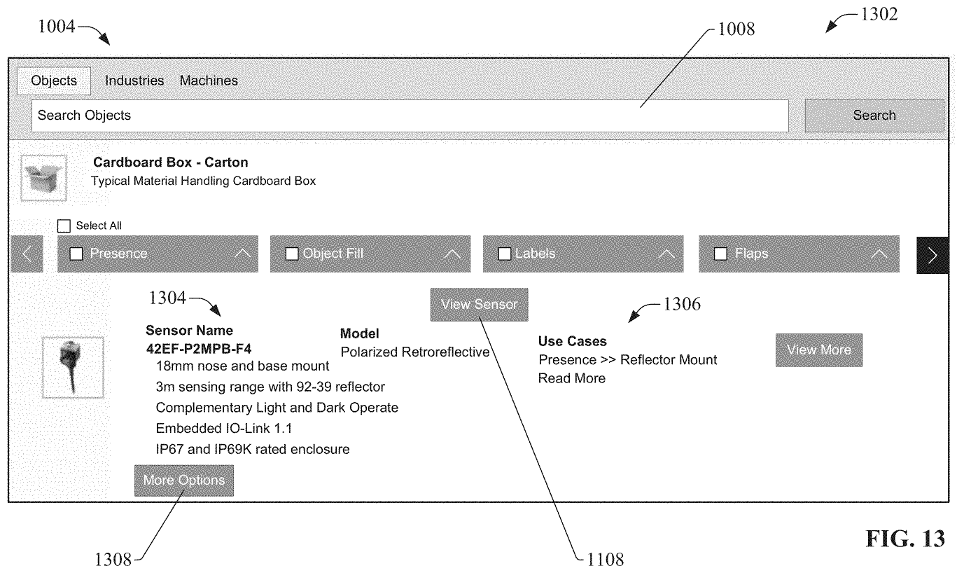

When a product and associated use cases and contexts have been selected, the user can select the View Sensor button 1108 to submit the selected search criteria. In response to selection of the View Sensor button 1108, sensor search component 106 generates and submits sensor search criteria 302 (see FIG. 3) to the library of sensor profiles 122 and identifies one or more sensor catalog numbers corresponding to respective sensors suitable for use within the sensing application defined by the user's selected product, use case, and contexts. Reporting component 112 can format information retrieved from the identified sensor profiles for presentation to the user. FIG. 13 is an example search result interface display 1302 that renders information regarding sensors suitable for the user's sensing application. A Results display area 1304 displays the selected sensor's name and catalog number, as well as a listing of some of the sensor's features (e.g., dimensions, sensing range, enclosure type, etc.). A use case display area 1306 can summarize the use case, contexts, and sub-contexts that had been selected by the user to yield the sensor search results.

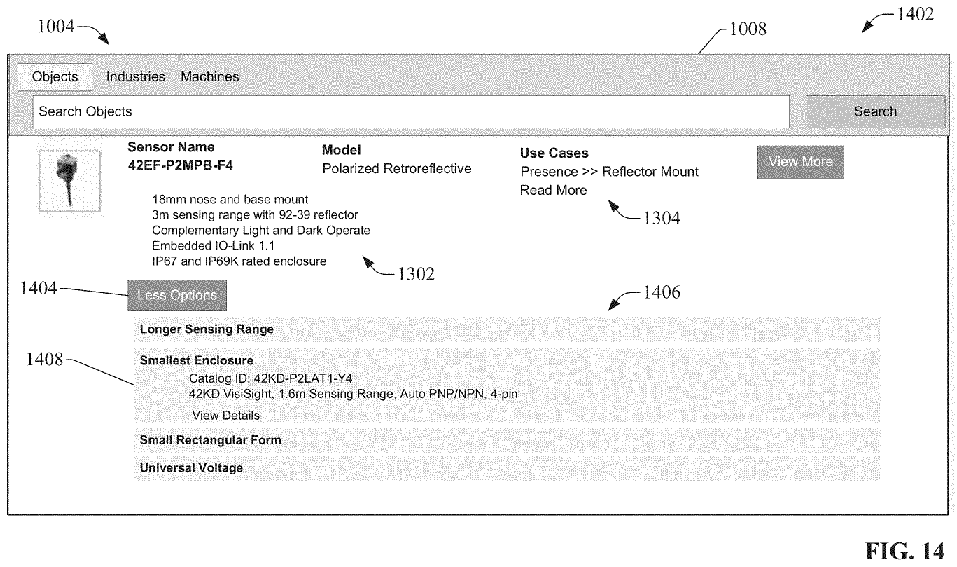

For scenarios in which more than one sensor has been identified as being suitable for the user's sensing application, reporting component 112 may select one of the candidate sensors for display in the result display area 1304 based on a selection criterion (e.g., most popular, lowest cost, etc.), and the other candidate sensors can be viewed by selecting a More Options button 1308 rendered at the bottom of the first display area. FIG. 14 is an example interface display 1402 that can be rendered in response to selection of the More Options button 1308. Selection of the More Options button 1308 causes a list of the other candidate sensors to be displayed as search results 1408 in a More Options display area 1406. To assist the user in selecting from among the candidate sensors, each candidate sensor is listed with an indication of an associated capability or property that distinguishes each sensor from the other candidate sensors (e.g., longer sensing range than the primary candidate sensor, smallest enclosure, smaller rectangular form, universal voltage, most waterproof, highest safety rating, etc.). This selection step corresponds to the sensor resolution process described above in connection with FIG. 6. In some embodiments, the details of the other candidate sensors remain hidden, with each search result 1408 only displaying its corresponding sensor's distinguishing characteristic, until the user selects the one of the results 1408. In the example depicted in FIG. 14, the user has selected the candidate sensor having the smallest enclosure of all the candidate sensors, causing the catalog number and specification information for the sensor to be displayed.

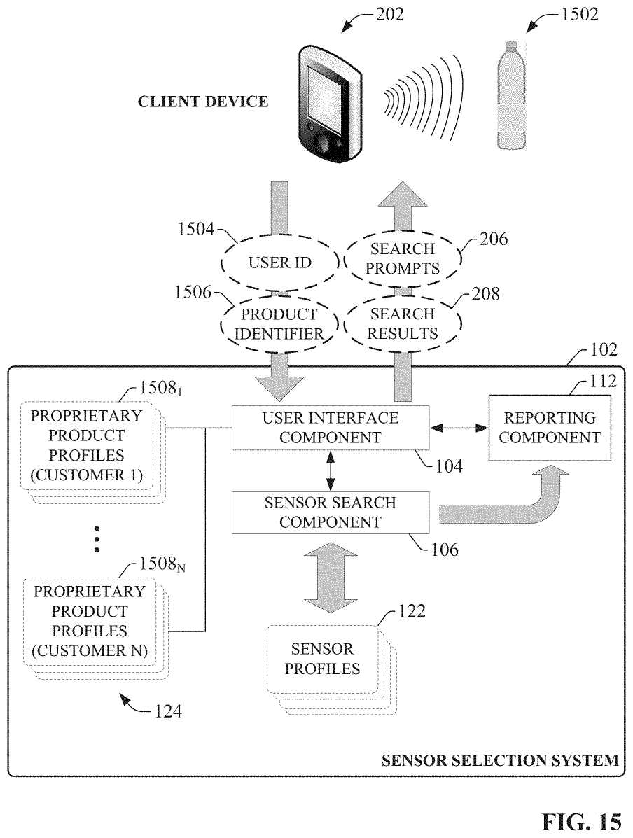

In the search-by-product examples described above, sensor selection system 102 allows the user to select a non-proprietary type of product or object to be detected or measured by a sensing application as a starting point for selecting an appropriate sensor. In some embodiments, the selection system 102 may also allow the user to specify a proprietary product manufactured solely by the user's industrial enterprise. FIG. 15 is a block diagram illustrating a generalized architecture of the sensor selection system 102 for embodiments that support proprietary product profiles. For embodiments in which sensor selection system 102 is embodied on a public network and made accessible to multiple users or customers across different industrial enterprises, profile library 124 may include sets of customer-specific product profiles 1508, where the product profiles of each set can only be invoked by users associated with the customer or enterprise to which the set belongs. Each customer-specific product profile 1508 can define use cases, contexts, and other specifics of a proprietary product manufactured by the customer, including any idiosyncratic features that distinguish the product from others of its type (e.g., in terms of shape, size, color, etc.) and which may factor into the selection of a suitable sensor for detecting or measuring a characteristic of the product.

In some embodiments, the user can identify the proprietary product in the first step of the sensor search flow by optically scanning (using client device 202) a scannable code, such as a quick response (QR) code, imprinted on the product. In the example depicted in FIG. 15, the optical scanning capabilities of client device 202 are used to read a barcode on a proprietary bottle 1502 manufactured by an industrial enterprise with which the user is associated. Client device 202 translates the scanned barcode to a product identifier 1506, which is submitted to the sensor selection system 102 via user interface component 104. In response to submission of the optically scanned product identifier, user interface component 104 can retrieve information about the product from the proprietary product profile 1508 corresponding to the product. In some embodiments, user interface component 104 may prompt the user for a user identifier and credentials 1504 (e.g., a username and password, biometric information, etc.) before allowing the details of the scanned product to be displayed, only rending the product details if the user's credentials indicate that the user is permitted to access the proprietary product information. Once the selection system 102 has identified the product, the sensor search flow proceeds as described in the search-by-product examples described above. The use of customer-specific product profiles can refine the search for a suitable industrial sensor based on specifics of the user's proprietary products. Although the example described in connection with FIG. 15 assumes that the product identifier 1506 is obtained via an optical scan of the product, some embodiments may also permit the user to identify the proprietary product by other means (e.g., by presenting a list of products defined for the industrial enterprise associated with the user identifier 1504, by capturing and submitting a photograph of the product that can be recognized by the system 202 using vision techniques, by submitting a stock photo of the product, etc.).

Embodiments of the sensor selection system described herein can assist both plant engineers and sales representatives in selecting or recommending an appropriate sensor for use in a given industrial sensing application without requiring a priori knowledge of the broad range of available sensors. By combining industry knowledge of common sensing applications with a comprehensive sensor catalog that covers sensors of various types and vendors, the selection system can quickly guide the user to an industrial sensor that best suits the needs of the user's application while reducing the risk of selecting an improper or incompatible sensor.

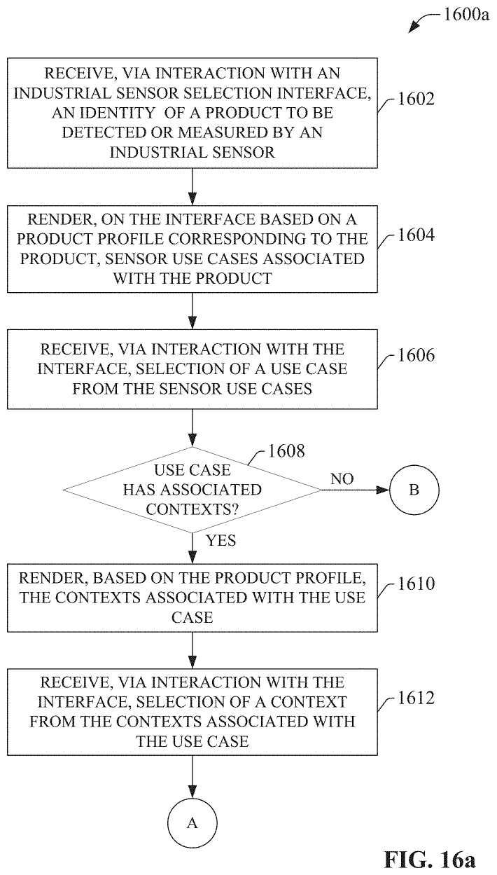

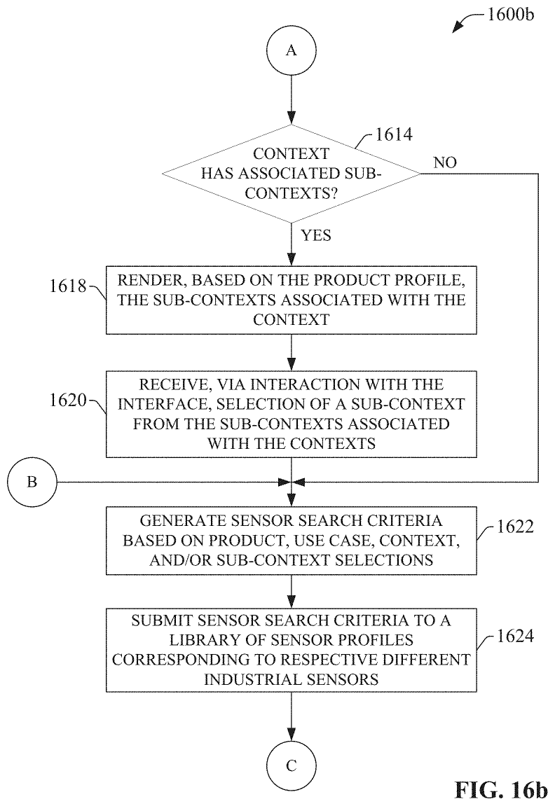

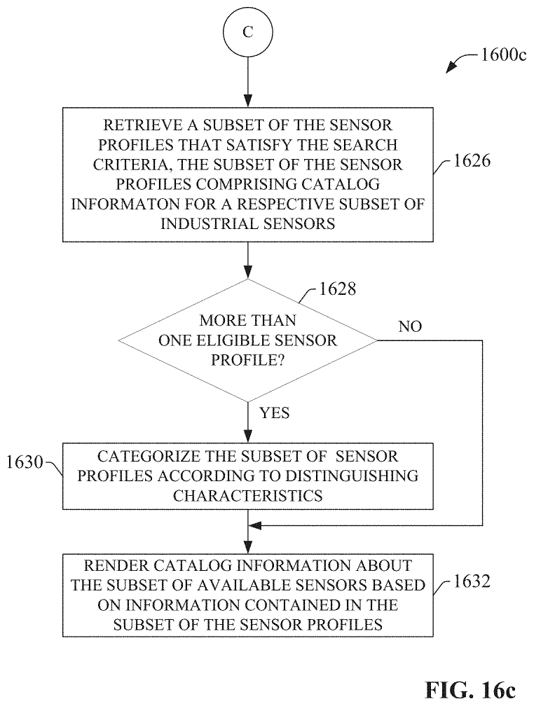

FIGS. 16a-16c illustrate a methodology in accordance with one or more embodiments of the subject application. While, for purposes of simplicity of explanation, the methodology shown herein is shown and described as a series of acts, it is to be understood and appreciated that the subject innovation is not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation. Furthermore, interaction diagram(s) may represent methodologies, or methods, in accordance with the subject disclosure when disparate entities enact disparate portions of the methodologies. Further yet, two or more of the disclosed example methods can be implemented in combination with each other, to accomplish one or more features or advantages described herein.

FIG. 16a is a first part of an example methodology 1600a for discovering a suitable sensor for an industrial sensing application by specifying a product to be detected or measured. Initially, at 1602, an identity of a product to be detected or measured by an industrial sensing application is received via interaction with an industrial sensor selection interface. In some embodiments, the sensor selection interface can be rendered on a client device by a remote sensor selection system (which may reside on a web server or on a cloud platform). The sensor selection interface can render icons representing pre-defined, selectable product types, including but not limited to bottles, jugs, cans, tires or other rubber products, automotive components, vehicles, pallets, packing material, food products, pharmaceutical products, or other manufactured items. In some embodiments, the sensor selection interface may also allow selection of a proprietary product manufactured solely by a particular industrial enterprise (contingent upon submission of verifiable credentials that confirm the user's association with the enterprise).

At 1604, in response to receipt of the identity of the product at step 1602, sensor use cases associated with the identified product are rendered based on information contained in a product profile corresponding to the identified product. The rendered use cases represent different sensing applications that are commonly applied to the identified product. For example, if the selected product is a bottle, example use cases that may be presented for selection can include, but are not limited to, detection of the bottle's presence, measurement of a fill level of the bottle, confirmation that the bottle's cap is in place, confirmation that the bottle's label is affixed, or other such characteristics of the product that may be targets of the sensing application.

At 1606, selection of a use case from the use cases rendered at step 1604 is received via interaction with the interface. At 1608, a determination is made as to whether the use case selected at step 1606 has associated contexts that can be selected in order to further define the sensing application for which a sensor is being selected. The contexts associated with the selected use case may be defined in the product profile, which can be referenced by the selection system in order to identify the contexts. If the selected use case has associated contexts (YES at step 1608), the methodology proceeds to step 1610, where the contexts associated with the use case are rendered. The contexts can represent additional contextual information about the use case that can be used by the system to accurately select a suitable sensor for the sensing application. This contextual information can include, for example, an indication of an opacity of the product (e.g., clear or opaque), a property of the product or a component of the product to be detected or measured, a sensor mounting preference, an indication of whether a fixed background is present in the sensing area, an indication of whether the property to be measured is a presence of the product or an optical code printed on the product, an environmental condition of the sensing area (e.g. a level of turbidity in the atmosphere, a level of vibration expected at the sensor mounting area, etc.) or other such contextual information. At 1612, a selection of one of the contexts from those rendered at step 1610 is received via interaction with the interface.

The methodology continues with the second part 1600b illustrated in FIG. 16b. At 1614, a determination is made as to whether the context selected at step 1612 has associated sub-contexts (e.g., as determined from the product profile). The sub-contexts may represent further information about the context selected at step 1612 that may factor into the final sensor selection. If the selected context is associated with optional additional sub-contexts (YES at step 1614), the methodology proceeds to step 1618, where the sub-contexts associated with the context are rendered on the interface based on the information obtained from the product profile. At 1620, a selection of one of the rendered sub-contexts is received via interaction with the interface.

Although steps 1604-1620 describe the rendering of the use cases, contexts, and sub-contexts as occurring sequentially in response to user selections, in some embodiments the use cases and their associated contexts and sub-contexts may be rendered simultaneously, grouped according to use case (e.g., as depicted in the example interface illustrated in FIG. 11), and the system can allow the user to select a use case and associated contextual options from this comprehensive set.

Once a use case and, if applicable, an associated context and related sub-context has been selected, the methodology proceeds to step 1622. The methodology also proceeds directly to step 1622 if the selected use case has no associated contexts (NO at step 1608) or if the selected context has no associated sub-contexts (NO at step 1614). At 1622, sensor search criteria are generated based on the product, use case, and (if applicable) context and sub-context selected in the previous steps. Collectively, the product, use case, context, and sub-context define the sensor application with a sufficient degree of granularity to allow the system to select one or more sensors from a catalog of available industrial sensors capable of carrying out the sensing application. At 1624, search data representing the sensor search criteria is submitted to a library of sensor profiles corresponding to respective different industrial sensors. Each sensor profile defines a catalog number and functional specification data for its corresponding industrial sensor.

The methodology continues with the third part 1600c illustrated in FIG. 16c. At 1626, a subset of the sensor profiles that satisfy the search criteria are retrieved. The subset of the sensor profiles comprise catalog information and functional specification data for a respective subset of industrial sensors capable of carrying out the sensing application defined by the target product, use case, context, and sub-context. At 1628, a determination is made as to whether the subset of sensor profiles retrieved at step 1626 include more than one eligible sensor profile. If more than one eligible sensor profile is retrieved (YES at step 1628), the methodology proceeds to step 1630, where the subset of the sensor profiles are categorized according to respective distinguishing characteristics. These distinguishing characteristics can include, for example, a longest sensing range, a smallest housing, a most durable, or other such characteristics. At 1632, catalog information about the subset of the available sensors is rendered based on information contained in the subset of the sensor profiles.

Embodiments, systems, and components described herein, as well as industrial control systems and industrial automation environments in which various aspects set forth in the subject specification can be carried out, can include computer or network components such as servers, clients, programmable logic controllers (PLCs), automation controllers, communications modules, mobile computers, wireless components, control components and so forth which are capable of interacting across a network. Computers and servers include one or more processors—electronic integrated circuits that perform logic operations employing electric signals—configured to execute instructions stored in media such as random access memory (RAM), read only memory (ROM), a hard drives, as well as removable memory devices, which can include memory sticks, memory cards, flash drives, external hard drives, and so on.

Similarly, the term PLC or automation controller as used herein can include functionality that can be shared across multiple components, systems, and/or networks. As an example, one or more PLCs or automation controllers can communicate and cooperate with various network devices across the network. This can include substantially any type of control, communications module, computer, Input/Output (I/O) device, sensor, actuator, instrumentation, and human machine interface (HMI) that communicate via the network, which includes control, automation, and/or public networks. The PLC or automation controller can also communicate to and control various other devices such as standard or safety-rated I/O modules including analog, digital, programmed/intelligent I/O modules, other programmable controllers, communications modules, sensors, actuators, output devices, and the like.

The network can include public networks such as the internet, intranets, and automation networks such as Common Industrial Protocol (CIP) networks including DeviceNet, ControlNet, and Ethernet/IP. Other networks include Ethernet, DH/DH+, Remote I/O, Fieldbus, Modbus, Profibus, CAN, wireless networks, serial protocols, near field communication (NFC), Bluetooth, and so forth. In addition, the network devices can include various possibilities (hardware and/or software components). These include components such as switches with virtual local area network (VLAN) capability, LANs, WANs, proxies, gateways, routers, firewalls, virtual private network (VPN) devices, servers, clients, computers, configuration tools, monitoring tools, and/or other devices.

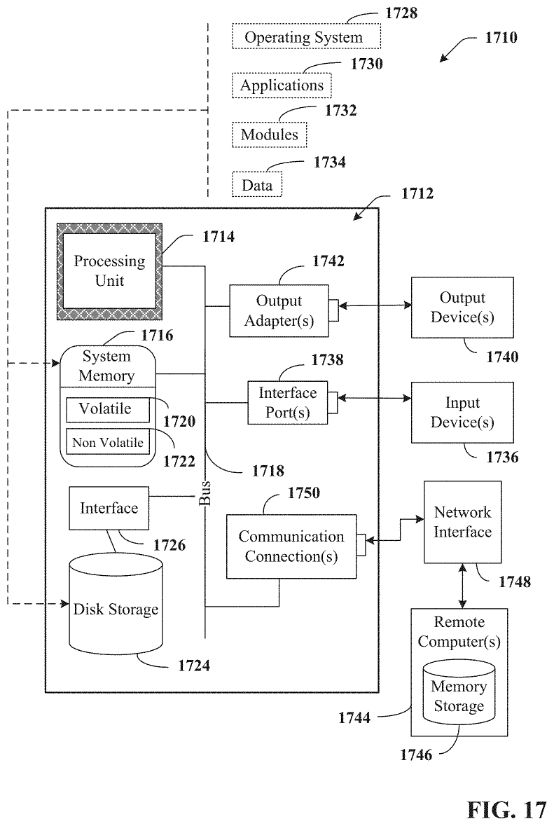

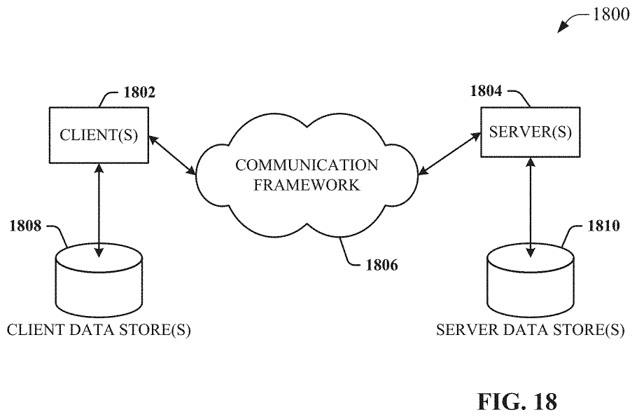

In order to provide a context for the various aspects of the disclosed subject matter, FIGS. 17 and 18 as well as the following discussion are intended to provide a brief, general description of a suitable environment in which the various aspects of the disclosed subject matter may be implemented.

With reference to FIG. 17, an example environment 1710 for implementing various aspects of the aforementioned subject matter includes a computer 1712. The computer 1712 includes a processing unit 1714, a system memory 1716, and a system bus 1718. The system bus 1718 couples system components including, but not limited to, the system memory 1716 to the processing unit 1714. The processing unit 1714 can be any of various available processors. Multi-core microprocessors and other multiprocessor architectures also can be employed as the processing unit 1714.

The system bus 1718 can be any of several types of bus structure(s) including the memory bus or memory controller, a peripheral bus or external bus, and/or a local bus using any variety of available bus architectures including, but not limited to, 8-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 1716 includes volatile memory 1720 and nonvolatile memory 1722. The basic input/output system (BIOS), containing the basic routines to transfer information between elements within the computer 1712, such as during start-up, is stored in nonvolatile memory 1722. By way of illustration, and not limitation, nonvolatile memory 1722 can include read only memory (ROM), programmable ROM (PROM), electrically programmable ROM (EPROM), electrically erasable PROM (EEPROM), or flash memory. Volatile memory 1720 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 1712 also includes removable/non-removable, volatile/non-volatile computer storage media. FIG. 17 illustrates, for example a disk storage 1724. Disk storage 1724 includes, but is not limited to, devices like a magnetic disk drive, floppy disk drive, tape drive, Jaz drive, Zip drive, LS-100 drive, flash memory card, or memory stick. In addition, disk storage 1724 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage 1724 to the system bus 1718, a removable or non-removable interface is typically used such as interface 1726.

It is to be appreciated that FIG. 17 describes software that acts as an intermediary between users and the basic computer resources described in suitable operating environment 1710. Such software includes an operating system 1728. Operating system 1728, which can be stored on disk storage 1724, acts to control and allocate resources of the computer 1712. System applications 1730 take advantage of the management of resources by operating system 1728 through program modules 1732 and program data 1734 stored either in system memory 1716 or on disk storage 1724. It is to be appreciated that one or more embodiments of the subject disclosure can be implemented with various operating systems or combinations of operating systems.

A user enters commands or information into the computer 1712 through input device(s) 1736. Input devices 1736 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1714 through the system bus 1718 via interface port(s) 1738. Interface port(s) 1738 include, for example, a serial port, a parallel port, a game port, and a universal serial bus (USB). Output device(s) 1740 use some of the same type of ports as input device(s) 1736. Thus, for example, a USB port may be used to provide input to computer 1712, and to output information from computer 1712 to an output device 1740. Output adapters 1742 are provided to illustrate that there are some output devices 1740 like monitors, speakers, and printers, among other output devices 1740, which require special adapters. The output adapters 1742 include, by way of illustration and not limitation, video and sound cards that provide a means of connection between the output device 1740 and the system bus 1718. It should be noted that other devices and/or systems of devices provide both input and output capabilities such as remote computer(s) 1744.

Computer 1712 can operate in a networked environment using logical connections to one or more remote computers, such as remote computer(s) 1744. The remote computer(s) 1744 can be a personal computer, a server, a router, a network PC, a workstation, a microprocessor based appliance, a peer device or other common network node and the like, and typically includes many or all of the elements described relative to computer 1712. For purposes of brevity, only a memory storage device 1746 is illustrated with remote computer(s) 1744. Remote computer(s) 1744 is logically connected to computer 1712 through a network interface 1748 and then physically connected via communication connection 1750. Network interface 1748 encompasses communication networks such as local-area networks (LAN) and wide-area networks (WAN). LAN technologies include Fiber Distributed Data Interface (FDDI), Copper Distributed Data Interface (CDDI), Ethernet/IEEE 802.3, Token Ring/IEEE 802.5 and the like. WAN technologies include, but are not limited to, point-to-point links, circuit switching networks like Integrated Services Digital Networks (ISDN) and variations thereon, packet switching networks, and Digital Subscriber Lines (DSL). Network interface 1748 can also encompass near field communication (NFC) or Bluetooth communication.

Communication connection(s) 1750 refers to the hardware/software employed to connect the network interface 1748 to the system bus 1718. While communication connection 1750 is shown for illustrative clarity inside computer 1712, it can also be external to computer 1712. The hardware/software necessary for connection to the network interface 1748 includes, for exemplary purposes only, internal and external technologies such as, modems including regular telephone grade modems, cable modems and DSL modems, ISDN adapters, and Ethernet cards.

FIG. 18 is a schematic block diagram of a sample computing environment 1800 with which the disclosed subject matter can interact. The sample computing environment 1800 includes one or more client(s) 1802. The client(s) 1802 can be hardware and/or software (e.g., threads, processes, computing devices). The sample computing environment 1800 also includes one or more server(s) 1804. The server(s) 1804 can also be hardware and/or software (e.g., threads, processes, computing devices). The servers 1804 can house threads to perform transformations by employing one or more embodiments as described herein, for example. One possible communication between a client 1802 and servers 1804 can be in the form of a data packet adapted to be transmitted between two or more computer processes. The sample computing environment 1800 includes a communication framework 1806 that can be employed to facilitate communications between the client(s) 1802 and the server(s) 1804. The client(s) 1802 are operably connected to one or more client data store(s) 1808 that can be employed to store information local to the client(s) 1802. Similarly, the server(s) 1804 are operably connected to one or more server data store(s) 1810 that can be employed to store information local to the servers 1804.

What has been described above includes examples of the subject innovation. It is, of course, not possible to describe every conceivable combination of components or methodologies for purposes of describing the disclosed subject matter, but one of ordinary skill in the art may recognize that many further combinations and permutations of the subject innovation are possible. Accordingly, the disclosed subject matter is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the disclosed subject matter. In this regard, it will also be recognized that the disclosed subject matter includes a system as well as a computer-readable medium having computer-executable instructions for performing the acts and/or events of the various methods of the disclosed subject matter.

In addition, while a particular feature of the disclosed subject matter may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

In this application, the word “exemplary” is used to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

Various aspects or features described herein may be implemented as a method, apparatus, or article of manufacture using standard programming and/or engineering techniques. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks [e.g., compact disk (CD), digital versatile disk (DVD) . . .], smart cards, and flash memory devices (e.g., card, stick, key drive . . . ).

What is claimed is:

1. An industrial sensor selection system, comprising:
a memory that stores executable components;
a processor, operatively coupled to the memory, that executes the executable components, the executable components comprising:
a user interface component configured to
render, on a client device, interface displays that prompt for selection of a product to be detected or measured by an industrial sensing application, and
in response to receiving, from the client device via interaction with the interface display, selection of the product, render sensor use cases associated with the product on the client device; and
a sensor search component configured to, in response to receiving, from the client device via interaction with the interface display, selection of a sensor use case of the sensor use cases, generate search criteria data defining sensor search criteria based on the product and the sensor use case, and retrieve, from a library of sensor profiles, a subset of the sensor profiles that satisfy the sensor search criteria,
wherein the user interface component is further configured to render, on the client device based on information contained in the subset of the sensor profiles, catalog information about one or more industrial sensors represented by the subset of the sensor profiles.

2. The industrial sensor selection of claim 1, wherein the product is at least one of a bottle, a tire, a can, a container, a packaging material, a food product, a pallet, an automotive part, a pharmaceutical product, or a vehicle.

3. The industrial sensor selection system of claim 1, wherein the sensor use cases comprise at least one of detection of a presence of the product, detection of a fill level of the product, detection of a label on the product, detection of a lid on the product, detection of a color of the product, scanning of a barcode on the product, or measurement of a dimension of the product.

4. The industrial sensor selection system of claim 1, wherein
the user interface component is further configured to, in response to receiving the selection of the sensor use case, render, on the client device, sensing application contexts associated with the sensor use case, and
the sensor search component is further configured to, in response to receiving, from the client device via interaction with the interface display, selection of a sensing application context of the sensing application contexts, generate the sensor search criteria based on the product, the sensor use case, and the sensing application context.

5. The industrial sensor selection system of claim 4, wherein the sensing application context comprises at least one of an opacity of the product, a type of material of which the product is made, a sensor mounting preference, an environmental condition in proximity of a sensing area, or an indication of whether the sensing area has a fixed background.

6. The industrial sensor selection system of claim 1, wherein the catalog information about the one or more industrial sensors comprises, for each industrial sensor of the one or more industrial sensors, a distinguishing feature that distinguishes the industrial sensor from other sensors of the one or more industrial sensors.

7. The industrial sensor selection system of claim 6, wherein the distinguishing feature is at least one of a longest sensing range, a smallest enclosure, a type of power supply, a highest durability rating, a fastest output signal response time, a highest safety rating, or a most energy efficient.

8. The industrial sensor selection system of claim 1, wherein
the user interface display is configured to prompt for the selection of the product from a set of registered products having respective product profiles stored on the memory, and
the product profiles comprise at least a first subset of the product profiles exclusively accessible to a first set of users associated with a first industrial enterprise and a second subset of the product profiles exclusively accessible to a second set of users associated with a second industrial enterprise.

9. The industrial sensor selection system of claim 8, wherein the user interface component is configured to receive the selection of the product as a product code optically scanned by the client device.

10. The industrial sensor selection system of claim 1, wherein the one or more industrial sensors comprise at least one of imaging sensors, three-dimensional sensors, inductive sensors, capacitive sensors, proximity sensors, or photo-electric sensors.

11. The industrial sensor selection system of claim 1, wherein the user interface component is further configured to render, on the client device, a recommended sensor configuration for one of the one or more industrial sensors based on the product and the use case.

12. A method for discovering an industrial sensor suitable for an industrial sensing application, comprising:
receiving, from a client device by a system comprising a processor, a selection of a product to be detected or measured by an industrial sensing application;
in response to receiving the selection of the product, rendering, on the client device by the system, sensor use cases associated with the product;
receiving, from the client device by the system, a selection of a sensor use case of the sensor use cases;
in response to receiving the selection of the sensor use case, generating, by the system, search data defining sensor search criteria based on the product and the sensor use case;
retrieving, by the system from a library of sensor profiles corresponding to respective industrial sensors, a subset of the sensor profiles that satisfy the sensor search criteria; and
rendering, on the client device by the system, catalog information about a subset of the industrial sensors represented by the subset of the sensor profiles based on information contained in the sensor profiles.

13. The method of claim 12, wherein the receiving the selection of a product comprises receiving a selection of at least one of a bottle, a tire, a can, a container, a packaging material, a food product, a pallet, an automotive part, a pharmaceutical product, or a vehicle.

14. The method of claim 12, wherein the rendering the sensor use cases comprises rendering, as the sensor use cases, at least one of detection of presence of the product, measurement of a fill level of the product, detection of a label on the product, detection of a lid on the product, detection of a color of the product, scanning of a barcode on the product, or measurement of a dimension of the product.

15. The method of claim 12, further comprising:
in response to the receiving the selection of the sensor use case, rendering, on the client device by the system, sensing application contexts associated with the sensor use case;
receiving, from the client device by the system, a selection of a sensing application context of the sensing application contexts; and
generating the sensor search criteria based on the product, the sensor use case, and the sensing application context.

16. The method of claim 15, wherein the rendering the sensing application contexts comprises rendering, as the sensing application contexts, at least one of an opacity of the product, a type of material of which the product is made, a sensor mounting characteristic, an environmental condition in proximity of a sensing area, or an indication of whether the sensing area has a fixed background.

17. The method of claim 12, wherein the rendering the catalog information comprises rendering, for each industrial sensor of the subset of the industrial sensors, an indication of a distinguishing feature that distinguishes the industrial sensor from other sensors of the subset of the industrial sensors.

18. The method of claim 12, further comprising rendering, on the client device by the system, recommended sensor configuration information for at least one of the subset of the industrial sensors based on the selection of the product and the selection of the use case.

19. A non-transitory computer-readable medium having stored thereon instructions that, in response to execution, cause a system comprising a processor to perform operations, the operations comprising:
receiving, from a client device, a selection of a product to be detected or measured by an industrial sensing application;
in response to receiving the selection of the product, rendering, on the client device, sensor use cases associated with the product;
receiving, from the client device, a selection of a sensor use case of the sensor use cases;
in response to receiving the selection of the sensor use case, generating sensor search data that defines sensor search criteria based on the product and the sensor use case;
retrieving, from a library of sensor profiles corresponding to respective industrial sensors, a subset of the sensor profiles that satisfy the sensor search criteria; and
rendering, on the client device, catalog information about a subset of the industrial sensors represented by the subset of the sensor profiles based on information contained in the sensor profiles.

20. The non-transitory computer-readable medium of claim 19, wherein the receiving the selection of a product comprises receiving a selection of at least one of a bottle, a tire, a can, a container, a packaging material, a food product, a pallet, an automotive part, a pharmaceutical product, or a vehicle.
